(19) United States
(12) Patent Application Publication
(10) Pub. No.: US 2026/0002570 A1
(43) Pub. Date: Jan. 1, 2026

(54) HYDRAULIC BRAKE CALIPER

(71) Applicant: SRAM, LLC, CHICAGO, IL (US)

(72) Inventors: CHARLES DUNLAP, COLORADO SPRINGS, CO (US); BRIAN JORDAN, CHICAGO, IL (US); KEVIN WESLING, LOMBARD, IL (US)

(73) Assignee: SRAM, LLC, CHICAGO, IL (US)

(21) Appl. No.: 18/755,960

(22) Filed: Jun. 27, 2024

(51) Int. Cl. F16D 65/74; B62L 3/02; F16D 55/00; F16D 55/226; F16D 65/00; F16D 65/28; F16D 121/04; F16D 125/08

(52) U.S. Cl. CPC F16D 65/74; F16D 55/226; F16D 65/0075; B62L 3/023; F16D 2055/002; F16D 65/28; F16D 2121/04; F16D 2125/08

(57) ABSTRACT

A brake caliper includes a caliper housing having a first cavity. A sleeve is disposed in the first cavity. The sleeve is reciprocally slidable relative to the caliper housing along an axial direction. The sleeve includes a second cavity. A piston is disposed in the second cavity. The piston is reciprocally slidable relative to the sleeve along the axial direction. A first seal is disposed between the sleeve and the caliper housing. A second seal is disposed between the piston and the sleeve.

### FIELD OF THE DISCLOSURE

The present application generally relates to a hydraulic brake caliper, including for example and without limitation a hydraulic brake caliper used on a bicycle.

### BACKGROUND

Bicycles may include hydraulic brake systems incorporating hydraulic brake calipers. Hydraulic brake calipers may be configured with one or more pistons that move one or more brake pads toward a brake rotor. Typically, a single seal is disposed between the piston and a caliper housing. The single seal may flex with the movement of the piston as the piston is actuated, with the seal then biasing the piston in the opposite direction to release the brake pad, otherwise referred to as a “rollback” function. As the brake pads wear over time, the piston is required to actuate a further distance in order for the brake pads to make adequate contact with the rotor. When the piston exceeds the flex range of the single seal, the piston may slide relative to the single seal in order to advance during braking. The combination of requiring the seal to both flex and slide may provide inconsistent rollback. In addition, if the worn brake pads are replaced with new, thicker brake pads, then the typical single seal system may require additional tools and installation effort to properly return the piston and seal to an initial setting such that the seal may again provide proper rollback to the piston and associated brake pad.

### SUMMARY

In one aspect, one embodiment of a brake caliper includes a caliper housing having a first cavity. A sleeve is disposed in the first cavity. The sleeve is reciprocally slidable relative to the caliper housing along an axial direction. The sleeve includes a second cavity. A piston is disposed in the second cavity. The piston is reciprocally slidable relative to the sleeve along the axial direction. A first seal is disposed between the sleeve and the caliper housing. A second seal is disposed between the piston and the sleeve.

In another aspect, one embodiment of a brake caliper includes a caliper housing having a first cavity. A sleeve is disposed in the first cavity, wherein the sleeve is moveable relative to the caliper housing along an axial direction. The sleeve includes a second cavity. A piston is disposed in the second cavity, wherein the piston is moveable relative to the sleeve along the axial direction. A first seal is disposed between the sleeve and the caliper housing, and a second seal is disposed between the piston and the sleeve. A first stop is disposed on the caliper housing. A second stop is spaced apart from the first stop along the axial direction, wherein a space between the first and second stops is adjustable. The sleeve is moveable between an actuated position, wherein the sleeve engages the first stop, and an at-rest position, wherein the sleeve engages the second stop.

In yet another aspect, one embodiment of a brake caliper includes a caliper housing having a gland defining a stop surface. A first stop is coupled to the housing and is spaced apart from the stop surface in an axial direction, wherein a distance between the first stop and the stop surface is fixed. A piston assembly is slidable relative to the caliper housing in the axial direction between an at-rest position, wherein the piston assembly is engaged with a second stop, and an actuated position, wherein the piston assembly is engaged with the first stop. A rollback seal is disposed in the gland between, and engaged with, the piston assembly and the caliper housing. A rollback adjuster defines the second stop, wherein the rollback adjuster is coupled to the caliper housing. The rollback adjuster is adjustable between a maximum rollback position, wherein the second stop is spaced from the first stop a first distance, and a minimum rollback position, wherein the second stop is spaced from the first stop a second distance, wherein the first distance is greater than the second distance.

The various aspects and embodiments of the brake caliper, and the methods for the adjustment and assembly thereof, provide significant advantages over other brake calipers and methods. For example and without limitation, the first seal, e.g. rollback seal, may flex and retract without sliding to accommodate movement of the sleeve relative to the caliper housing. The sleeve may have a limited range of movement, defined by a gap, which may prevent the sleeve from sliding relative to the rollback seal. The gap may be fixed or adjustable, for example by the user. The second seal, e.g., piston seal, is sealingly engaged between the piston and the sleeve, and may also provide a rollback function in one or more embodiments. In other embodiments, the piston seal does not provide any rollback function. The combination of the first and second seals provides more consistent flex advancement and retraction by the rollback seal, and more precise slide advancement by the piston seal. The more precise piston seal behavior allows for a controlled sliding retraction when replacing worn brake pads with new, thicker brake pads, thereby obviating the need for manual spreading of the brake pads and piston(s).

In one embodiment, the user may adjust and vary the gap between the sleeve and a stop, thereby adjusting or varying the amount of clearance between the brake pad and the rotor. In this way, the user may individualize the clearance. For example, the user may increase the gap to eliminate or reduce pad-rotor rub. Conversely, the user may decrease the gap to reduce the initial actuation travel at the hydraulic pump, i.e., reduce the amount of brake lever pull.

The foregoing paragraphs have been provided by way of general introduction and are not intended to limit the scope of the claims presented below. The various preferred embodiments, together with further advantages, will be best understood by reference to the following detailed description taken in conjunction with the accompanying drawings.

### BRIEF DESCRIPTION OF THE DRAWINGS

Objects, features, and advantages of the present invention will become apparent upon reading the following description in conjunction with the drawing figures, in which:

FIG. 1 is a side view of one embodiment of a bicycle assembled with a hydraulic brake system.

FIGS. 2A and B are partial side and end views of a portion of a bike frame and brake system.

FIG. 3 is a perspective view of one embodiment of a brake caliper.

FIG. 4 is an exploded perspective view of the brake caliper shown in FIG. 3.

FIG. 5 is a perspective of an alternative embodiment of a brake caliper and rotor.

FIG. 6 is an exploded perspective view of the brake caliper and rotor shown in FIG. 5.

FIG. 7 is a side view of the brake caliper shown in FIG. 3.

FIG. 8 is a cross-sectional view of the brake caliper shown in FIG. 7 taken along line 8-8.

FIG. 9 is a cross-sectional view of the brake caliper shown in FIG. 7 taken along line 9-9.

FIG. 10 is an enlarged partial cross-sectional view of the brake caliper taken along line 10 in FIG. 9.

FIGS. 11A and B are front and rear views of one embodiment of a sleeve.

FIG. 12 is a cross-sectional view of one embodiment of a rollback seal.

FIG. 13 is a cross-sectional view of one embodiment of a piston seal.

FIGS. 14A-D are partial cross-sectional views of the brake caliper showing a maximum rollback, intermediate rollback, minimum rollback and fully actuated positions.

FIGS. 15A and B are cross-sectional views of an alternative brake caliper shown in an at-rest position and an actuated position respectively.

FIG. 16 is a partial cross-sectional view of an alternative embodiment of a brake caliper.

FIG. 17 is a partial cross-sectional view of an alternative embodiment of a brake caliper.

### DETAILED DESCRIPTION OF THE DISCLOSURE

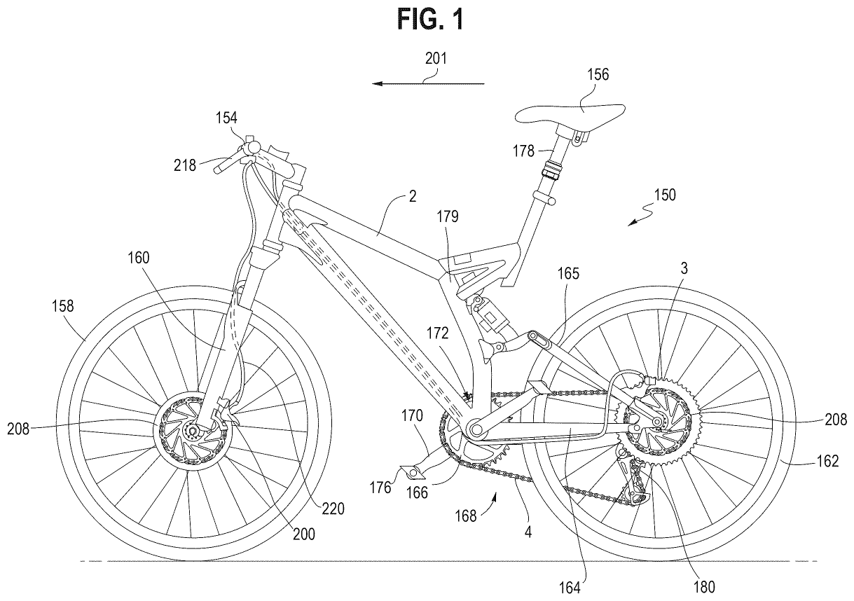

It should be understood that the term “plurality,” as used herein, means two or more. The term “longitudinal,” as used herein means of or relating to a length or lengthwise direction. The term “lateral,” as used herein, means situated on, directed toward or running in a side-to-side or axial direction 8. The term “coupled” means connected to or engaged with, whether directly or indirectly, for example with an intervening member, and does not require the engagement to be fixed or permanent, although it may be fixed or permanent. The terms “first,” “second,” and so on, as used herein are not meant to be assigned to a particular component so designated, but rather are simply referring to such components in the numerical order as addressed, meaning that a component designated as “first” may later be a “second” such component, depending on the order in which it is referred. It should also be understood that designation of “first” and “second” does not necessarily mean that the two components or values so designated are different, meaning for example a first direction may be the same as a second direction, with each simply being applicable to different components. The terms “upper,” “lower,” “rear,” “front,” “fore,” “aft,” “vertical,” “horizontal,” “right,” “left,” “inboard,” “outboard” and variations or derivatives thereof, refer to the orientations of an exemplary bicycle 150, shown in FIG. 1, from the perspective of a user seated thereon, for example with an “inboard” component or feature being closer to a vertical mid-plane of the bicycle extending in a direction 201. The term “transverse” means non-parallel. The terms “outer” and “outwardly” refers to a direction or feature facing away from a centralized location, for example the phrases “radially outwardly,” “radial direction” and/or derivatives thereof, refer to a feature diverging away from a centralized location, for example an axial direction 8 shown in FIGS. 4 and 6. Conversely, the terms “inward” and “inwardly” refers to a direction facing toward the centralized or interior location. The term “subassembly” refers to an assembly of a plurality of components, with subassemblies capable of being further assembled into other subassemblies and/or a final assembly, such as the bicycle 150.

### Bicycle:

FIG. 1 illustrates one embodiment of a human powered vehicle. In the example shown, the vehicle is one possible type of bicycle 150, such as a mountain bicycle. It should be understood that the various embodiments of the hydraulic brake caliper may be used on other types of human powered vehicles, including for example and without limitation road bicycles. In FIG. 1, a normal riding or forward moving direction 201 of the bicycle 150 is shown. The bicycle 150 has a frame 2, handlebars 154 near a front end of the frame 2, brake levers 218 secured to the handlebars, and a seat or saddle 156 for supporting a rider over a top of the frame 2. The bicycle 150 has a first or front wheel 158 carried by a front fork 160 supporting the front end of the frame 2. The bicycle 150 also has a second or rear wheel 162 supporting a rear end of the frame 2, which includes a pair of chain stays 164 connected to a pair of seat stays 165 at a junction or apex. The bicycle 150 also has a drive train 168 with a crank assembly 166 that is operatively coupled via a bicycle chain 4 to a rear cassette 3, otherwise referred to as a driven sprocket assembly, near a hub providing a rotation axis of the rear wheel 162. The crank assembly 166 includes at least one, and typically two, crank arms 170 and pedals 176, along with a front chainring assembly 172, or drive sprocket assembly. A crank spindle or shaft may connect the two crank arms. The crank shaft defines a center rotational axis of the chainring assembly 172. The crank assembly may also include other components.

A rear gear change device, such as a rear derailleur 180, is disposed at the rear wheel 162 to move the bicycle chain 4 to different sprockets of the cassette 3. In one embodiment, a front gear changer device, or front derailleur, may be provided to move the chain 4 to different sprockets of the chainring assembly. In the illustrated example, the saddle 156 is supported on a seat post 178 having an end portion received in a top of a frame seat tube 179 of the frame 2.

### Brake System:

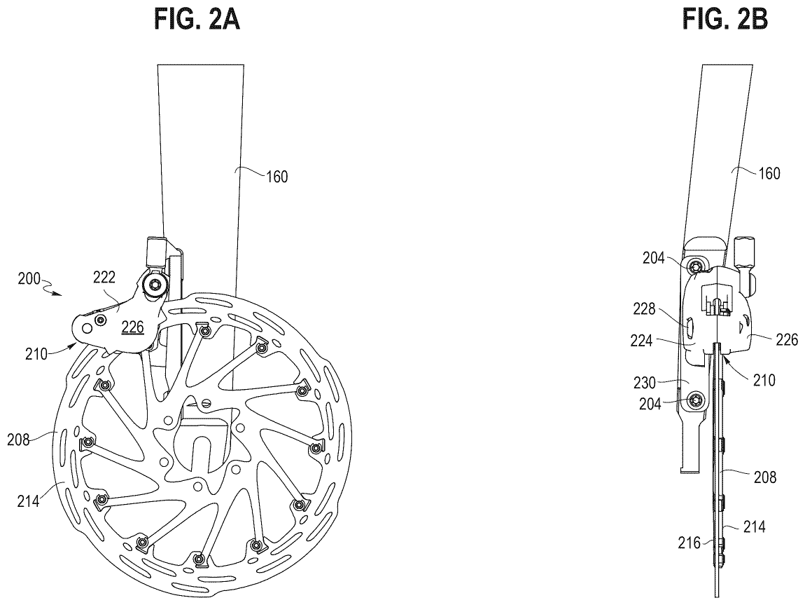

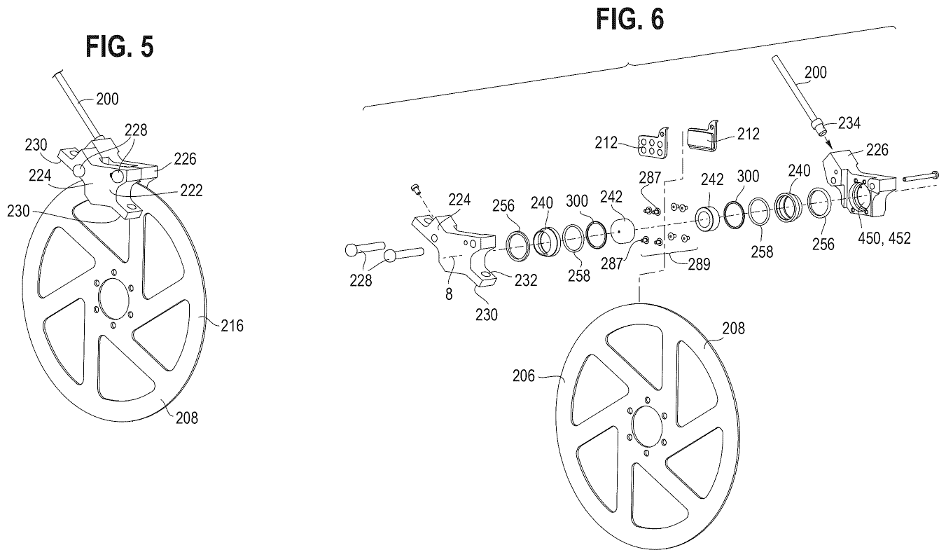

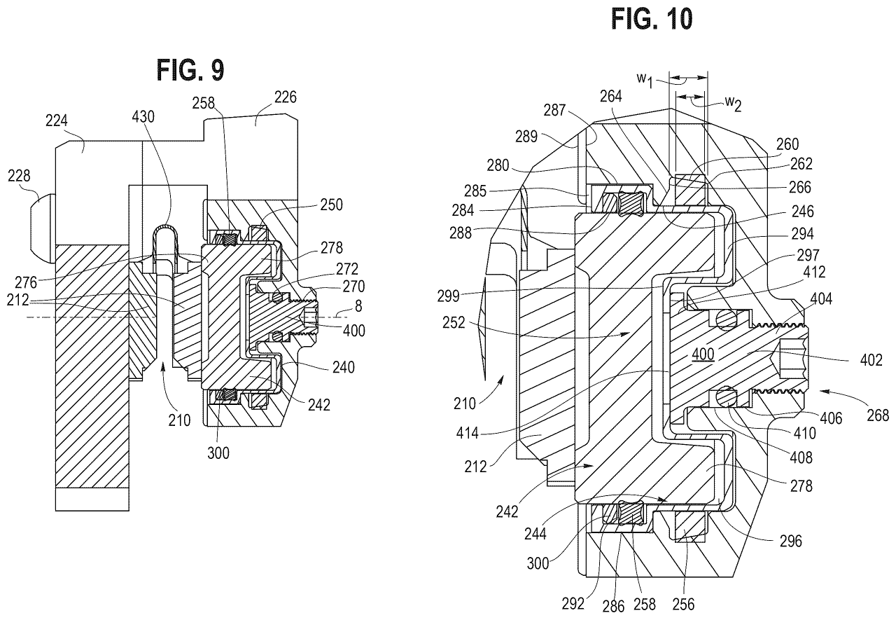

Referring to FIGS. 1 and 2A and B, a brake system 200 is coupled to the bicycle frame 2, for example the front fork 160, or the rear seat stay 165. The brake system 200 includes a caliper 202 secured to the frame, e.g., front fork 160, for example with a pair of bolts 204, and a rotor 208 secured to the front or rear wheel. The rotor 208 is rotatable relative to the caliper 202 and is disposed within a slot 210 defined by the caliper 202. Referring to FIGS. 4, 6 and 8-10, the caliper 202 includes a pair of opposing brake pads 212 that engage opposite sides 214, 216 of the rotor 208 when actuated to slow and/or stop the rotation of the rotor, attached wheel and bicycle. The caliper 202 is in fluid connection with the brake lever 218 by way of a conduit 220, shown for example in FIGS. 1, 5 and 6. The brake lever 218 may be actuated (e.g., pulled) to increase the hydraulic pressure in the conduit 220 and thereby pressurize the caliper 202, and components therein, so as to actuate the brake pads 212 and move them into engagement with opposite sides 214, 216 of the rotor 208. Separate hydraulic systems may be provided for the front and rear wheels 158, 162 and calipers 202 associated with each wheel.

### Caliper:

Referring to FIGS. 2A and B, 4, 6 and 8-10, the caliper 202 includes a housing 222, configured in one embodiment with an outboard caliper portion 224 and an inboard caliper portion 226, which are secured to each other to form and define the rotor slot 210. The caliper portions may be secured or coupled to each other, for example, with fasteners 228, shown as a pair of bolts. The caliper housing 222, including the outboard and inboard portions 224, 226, may be made from aluminum alloy, or other similar and/or suitable materials. The housing 222 includes a mounting arrangement 230, shown in one embodiment as a pair of platforms, which are configured to be mounted to a base components, including for example and without limitation a vehicle frame, fork 160, or chassis member. In one embodiment, the mounting arrangement 230 includes one or more mounting holes 232 located on the outboard caliper portion 224, with a pair of fasteners securing the housing to the base component. Other configurations of the mounting arrangement may include one or more of mounting holes, slots, threads, dovetail features, or clamping mechanisms, which may be used to mount the caliper to a vehicle member, and these configuration features may be disposed on either the inboard or the outboard caliper portion.

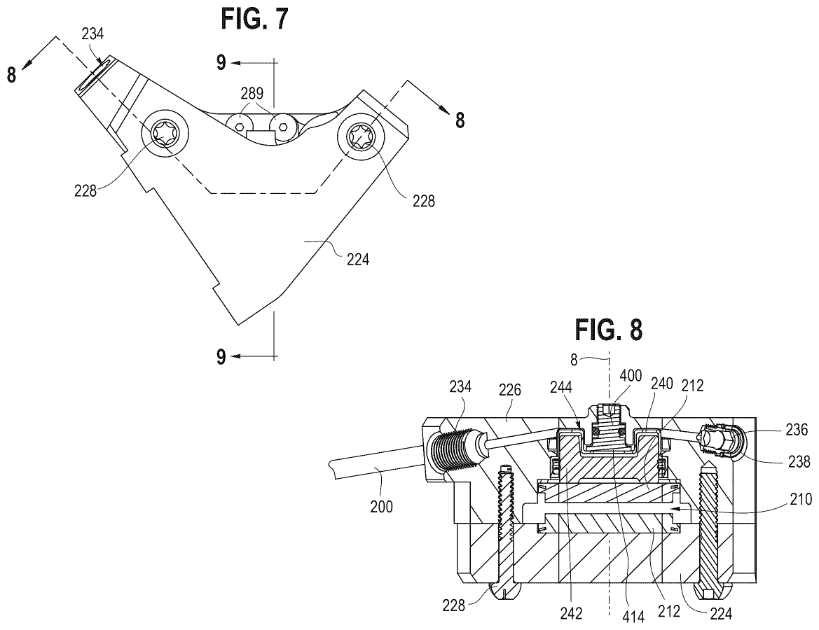

As shown in FIGS. 7 and 8, the caliper housing 222 includes a fluid inlet having a port 234, configured with a fitting in one embodiment, in fluid communication with the conduit for communicating hydraulic fluid to and from the hydraulic pump or master cylinder actuated by the lever 218. A bleed fitting 236, inserted into a bleed port 238, is used for filling the caliper with hydraulic fluid and for evacuating air in a bleeding process. The fluid inlet, or port 234 is in fluid communication with both a sleeve 240 and a piston 242 disposed in the housing 222. The bleed port 238 and the fluid inlet, or port 234, are in fluid communication with each other via a cavity 244, defining a cylinder, formed in and defined by the caliper housing, which receives the sleeve 240 and piston 242. These ports communicate with the cavity adjacent, or close to, the closed end of cavity to allow for unrestricted fluid flow to the piston and sleeve, and also to avoid interfering with the rollback function of the rollback seal, explained in more detail below.

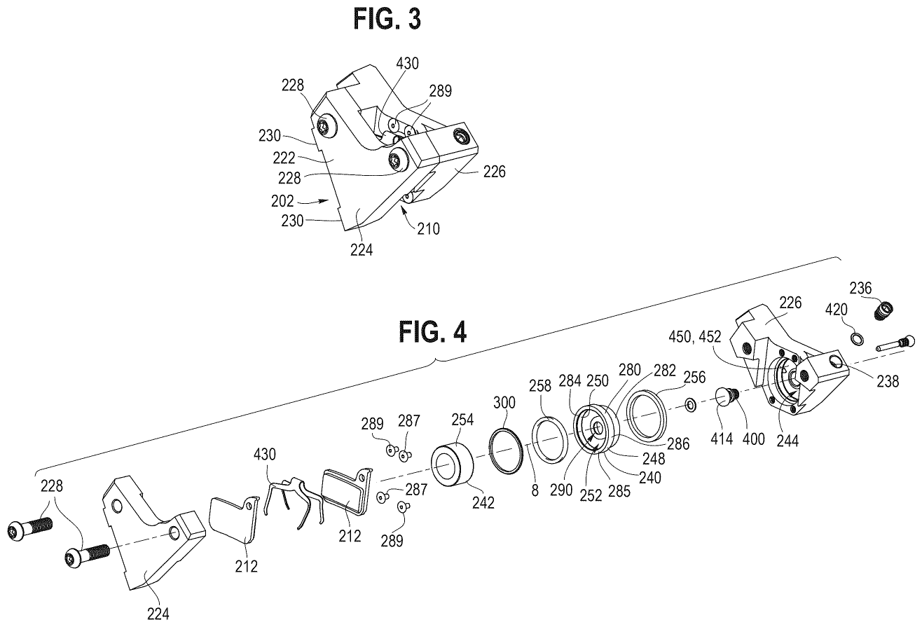

In one embodiment, shown in FIGS. 3, 4 and 7-9, the caliper 202 may include an actuating inboard caliper portion 226 and a non-actuating outboard caliper portion 224. The actuating and non-actuating caliper portions 226, 224 may also be switched to the outboard and inboard portions respectively. In other embodiments, shown for example in FIGS. 2, 5 and 6, the caliper may include both inboard and outboard caliper portions 224, 226 with an actuating function. In one embodiment, the fasteners 228 slide through the outboard caliper portion 224 and threadably engage the inboard caliper portion 226 to create the caliper housing 222. Conversely, the bolts may slide through the inboard caliper portion and threadably engage the outboard caliper portion. The inboard caliper portion 226 and outboard caliper portion 224 may also be fastened to one another with screws, bolts, rivets, or welding, or may be configured as a single unitary piece. In one embodiment, which includes only a single actuating caliper portion, the non-actuating portion, e.g., outboard caliper portion 224, is not configured with any hydraulic chambers, cylinders, or features, and when assembled one brake pad will be disposed on its flat, inside surface.

In the embodiment of FIG. 6, both actuating caliper portions 224, 226 include a piston 242 and a sleeve 240 in fluid communication with the hydraulic fluid, while in the embodiment of FIG. 4, only the inboard caliper portion 226 is configured with the piston 242 and sleeve 240. In either embodiment, the caliper housing 222, for example the inboard caliper portion 226, has a first interior surface 246 defining the cavity 244. The rollback sleeve 240 has an exterior surface 248 and an interior surface 250. The interior surface defines a second cavity 252. The piston 242 has a second exterior surface 254. A rollback seal 256 is disposed between and engages the interior surface 246 and the exterior surface 248, while a piston seal 258 is disposed between and engages the interior surface 250 and the exterior surface 254.

The rollback seal 256 and piston seal 258 are shown in the drawings in an uncompressed state, with the profile extending outside of glands 260, 292 housing the seals. It should be understood that the rollback seal 256 and piston seal 258 are, in actuality, compressed to fit within the glands 260, 292. The seals are shown in the uncompressed state to provide clarity about the shape of the seals and the size thereof relative to the glands.

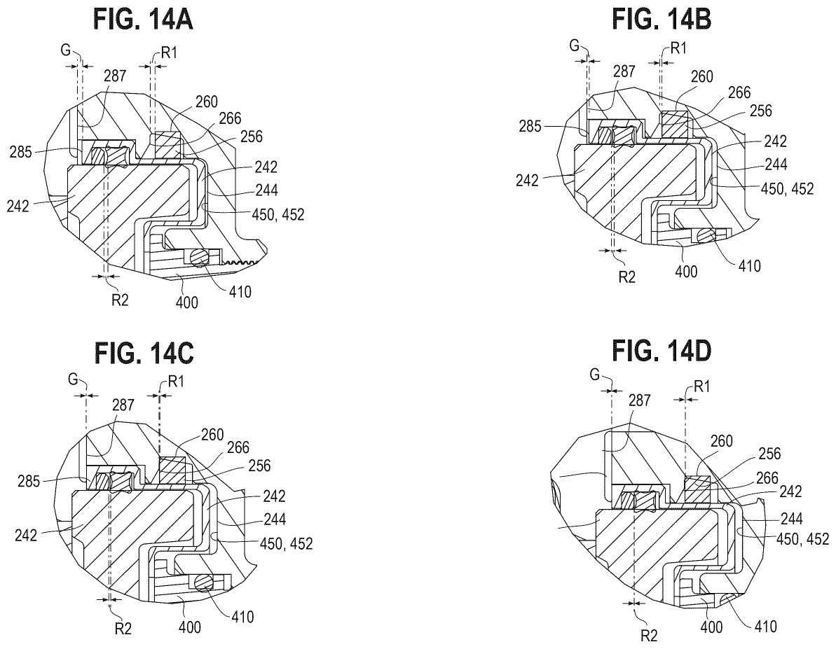

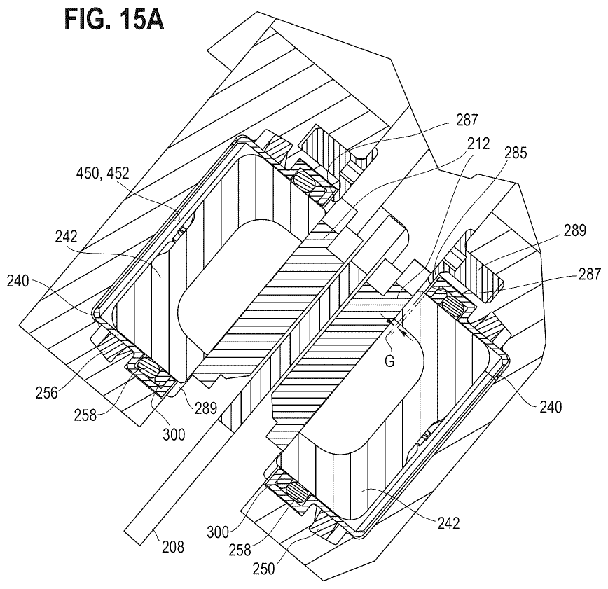

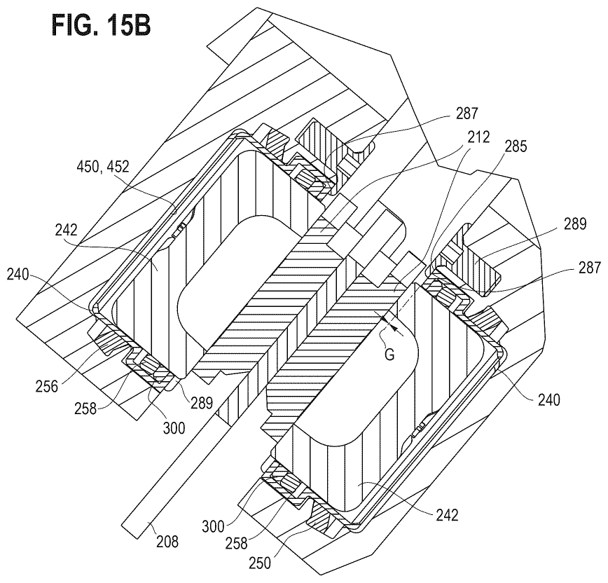

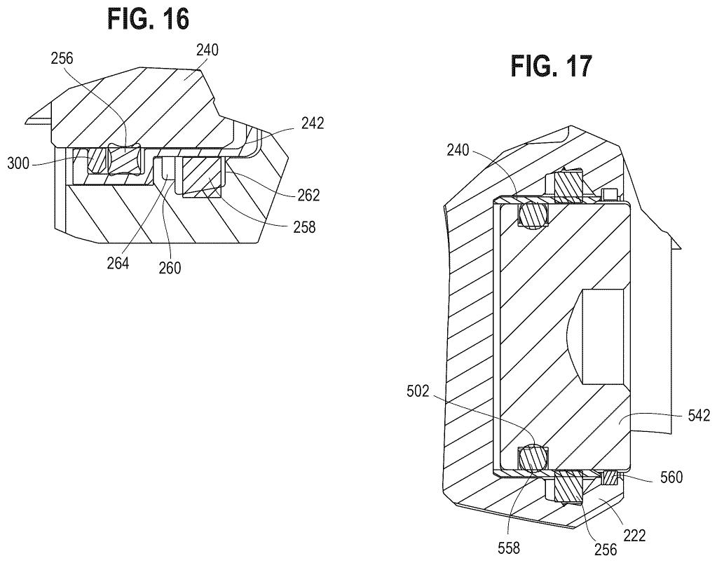

As shown in FIGS. 10 and 14A-D, a peripheral or annular groove extends circumferentially around the first cavity 244, and defines a peripheral or annular gland 260, which houses the rollback seal 256. The gland has a first width (W1) defined in the axial direction 8 and the rollback seal 256 has a second width (W2) defined in the axial direction 8, wherein the first width (W1) is greater than the second width (W2). The gland 260 is stepped and includes first and second portions 262, 264 with different shapes to define a shoulder or stop surface 266 at the junction therebetween, as shown in FIGS. 10 and 16. In one embodiment, a portion of the rollback seal 256 is deformable into the second portion 264 of the gland as the sleeve 240 is moved, e.g. slid, relative to the caliper housing 222 and the rollback seal 256 engages the stop surface 266, as shown for example in FIG. 15B. When the brake lever is released, the rollback seal biases the sleeve from an actuated position toward an at-rest position. The second portion 264 may include a tapered wall, or chamfer, intersecting a wall of the first portion 262, as shown in FIG. 10, or may include a stepped portion as shown in FIG. 16, with the corner defined between the portions defining the stop surface 266. In another embodiment, the second portion may be defined by a chamfer or tapered wall extending from the outermost wall of the first portion.

The caliper housing 222 also includes in one embodiment an opening 268 communicating with the cavity 244. The opening 268 may include different cylindrical portions 270, 272 having first and second diameters, defining a shoulder. The first portion 270 is threaded.

The sleeve 240 is disposed in the cavity 244, and is reciprocally slidable in the cavity 244 relative to the caliper housing 222 along an axial direction 8. The piston 242 is disposed in the cavity 252, and is reciprocally slidable in the cavity 252 relative to the sleeve 240 along the axial direction 8. The piston 242 includes an outer diameter seal surface 254. The piston 242 has an axial facing brake pad surface 274 in contact with the brake pad 212. The piston 242 may be made from phenolic, aluminum, stainless steel, or other similar and suitable polymers or metals. In one embodiment, the piston 242 has a I or H shape in cross section, with an outboard annular rib 276 defining an outboard central cavity and an inboard annular rib 278 defining an inboard central cavity, with the inboard rib 278 engaging the brake pad 212. In an alternative embodiment, shown in FIG. 17, the piston is configured with an annular groove, defining a gland 502. A piston seal 558 is disposed in the gland and slidingly engages the sleeve 240. In this embodiment, the rollback seal 256 is closer to the brake pad 212 than the piston seal 558. A ring 560 may be secured to the housing to define a stop for the sleeve 240.

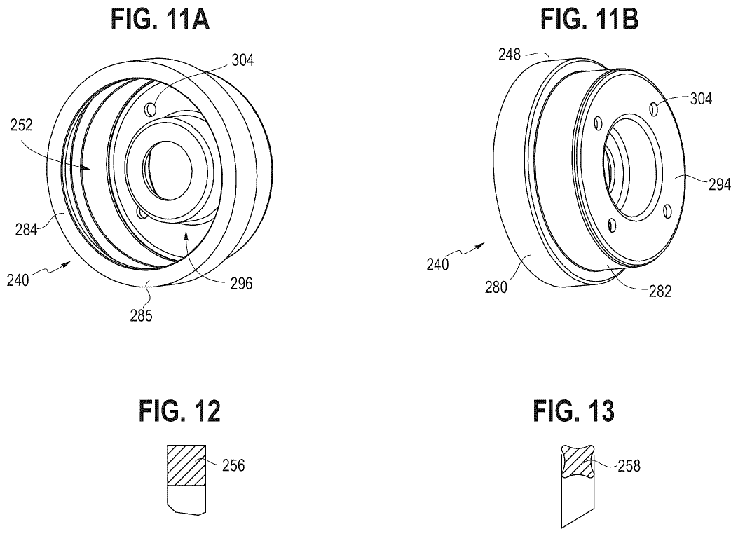

Referring to FIGS. 4, 6 and 11A and B, the sleeve 240 may be made from aluminum, stainless steel, or other similar and suitable metals or alloys. The outer or exterior surface 248 of the sleeve 240 has a portion defined by a first annular portion 280 (e.g., inboard) having a first diameter and a second annular portion 282 (e.g., outboard) defining a second diameter, wherein the first diameter is greater than the second diameter. The first annular portion 280 has an inboard face defined by an annular lip 284 radially inwardly from an annular wall 286 and defining a peripheral/circumferential edge 288 and a central opening 290. The inboard face defines a stop surface 285. The annular portion 280 defines an interior annular channel, or gland 292. An outboard face 294 closes off the inboard side of the annular portion 282 The outboard face includes a first ring portion that defines a donut shaped cavity 296, which is shaped to receive the annular rib 278 of the piston, and a central hub portion 299 defining a stop surface 297 on a face thereof. The central hub portion of the outboard face is configured with a plurality of ports or vents 304 (shown as four), which allow fluid flow from one side of the outboard face, or exterior of the sleeve, to the other side, or interior of the sleeve defining the cavity 252. The sleeve vents 304 are formed in in the end of the sleeve and communicate with the cavity along an axial direction, or parallel to the movement of the sleeve, and thereby allow unrestricted fluid communication from the cavity 244 to the cavity 252, and by extension the piston 242.

The annular cavity, or gland 292, houses the piston seal 258 and a piston backup ring 300, which may be omitted in one embodiment. The piston backup ring 300 may be positioned closer to the brake pad 212 than to the piston seal 258. The rollback seal 256 and is positioned further from the brake pad 212 than the piston seal 258. In other configurations, it is possible to have the rollback seal 256 positioned closer to the brake pad 212 than the piston seal 258. The sleeve stop surface 285 contacts a stop surface 287, defined by one or more (shown as four) sleeve stops 289, configured as bolts, which create a physical stop for the rollback sleeve when subjected to fluid pressure. The stop bolts, or the heads thereof, overhang the cavity 244, and are threadably engaged with the housing 222, and the inboard caliper portion 226 in particular.

As discussed herein, the rollback seal 256 is disposed between the outer/exterior surface of the sleeve 240 and an inner/interior surface of the caliper housing 222, while the piston seal 258 is disposed between an outer/exterior surface of the piston 242 and an inner/interior surface of the sleeve 240. As shown for example in FIGS. 12 and 13, the piston and rollback seals 256, 258 may each have the same or different cross-sections, including a floret, round, square, or u-cup cross-section, and may be made from EPDM rubber, buna-nitrile rubber, or other rubber like compounds. The piston backup ring 300 is optionally installed adjacent to the piston seal 258, preferably on the atmospheric, or ambient environment, side of the piston seal, to minimize friction contact and to seal any gaps between the slave piston and the sleeve. The piston backup ring 300 may be made from Delrin or PTFE (Teflon) or other similar plastic-like materials. The rollback seal 256 creates a seal between the caliper housing 222 and the rollback sleeve 240, while the piston seal 258 creates a seal between the rollback sleeve 240 and the piston 242.

### Rollback Adjuster:

Referring to FIGS. 4 and 7-10, the caliper 202 may optionally be configured with a rollback adjuster 400 in one embodiment. The rollback adjuster 400 may be located on the inboard caliper portion 226, the outboard caliper portion 224, or one each. The rollback adjuster 400 may be threadably engaged with the caliper housing 222, e.g., the inboard caliper portion 226 or outboard caliper portion 224. In one embodiment, the rollback adjuster 400 includes a shaft 402 with a first portion 404 threadably engaged with the opening 268 in the housing 222, for example the portion 270. A second portion 406 includes an annular groove 408 disposed in the second portion of the cylinder. A rollback adjust seal 410 is disposed in the groove 408 between the adjuster shaft 402 and an inner surface of the caliper housing, e.g., portion 272, to create a seal between the rollback adjuster 400 and the housing 222, e.g., inboard caliper portion 226. The adjuster 400 includes an enlarged end portion 412 having a face defining a stop 414. The stop 414 abuts and engage the central hub portion 299, or opposing stop surface 297, of the rollback sleeve to define the rollback position of the sleeve 240 relative to the housing 222.

As shown in FIGS. 4 and 8, a bleed fitting seal 420 creates a seal between the bleed fitting 236 and the inboard caliper portion 226. Opposite the bleeding fitting is the fluid inlet sealed from atmosphere by a conduit 220 and port 234 configured with a fitting. Together, the rollback seal 256, piston seal 258, bleed fitting seal 420, and hose connection at the port 234 seal the brake fluid system from communicating with the ambient environment or atmosphere. A pad spreader spring 430 biases the brake pads 212 away from the brake rotor 208, and maintains engagement between the brake pad(s) 212 and the piston(s) 242 or caliper portion 224. The plurality bolts (shown as four (4)) create a stop 289 with stop surface 287, which limit or stop the actuation/movement of rollback sleeve 240 towards the rotor 208. An axial face 450 within the inboard caliper 226 portion creates a second stop 452 that limits or stops the movement/retraction of the rollback sleeve 240 away from the rotor, either when an adjuster is not incorporated into the embodiment as shown in FIGS. 6 and 15A and B, or when the adjuster is at a maximum rollback position. Alternatively, the adjuster 400 may define the second stop 414, even when the adjuster is at the maximum rollback position as shown in FIG. 14A.

The adjuster 400 may be used to provide a moveable second stop 414 to limit the rollback sleeve retraction away from the rotor. With no adjuster, the second stop is fixed and defined by the caliper housing 222. The adjuster 400 may be made from aluminum, stainless steel, or other sufficient strength materials.

The pad gap is the distance between the inboard and outboard brake pads 212 when unactuated and biased away from the rotor by the pad spreader spring, shown for example as a value of 2.45 mm. This nominal value is variable when the adjuster 400 is incorporated, and fixed when no adjuster is provided. Other embodiments may have a pad gap value as little as 1 mm or as large as 10 mm, dependent on brake pad 212 and rotor 208 thickness.

The first and second stops 289, 414, 452 are spaced apart along the axial direction 8. The sleeve 240 is moveable between an actuated position, wherein the sleeve 240, or stop surface 285 engages the first stop 289 (e.g., stop surface 287) and an at-rest position, wherein the sleeve 240, or stop surface 297, engages the second stop 414, 452. As noted, in one embodiment, the space between the first and second stops or stop surfaces 287, 414 is adjustable, with the adjuster 400 defining the second stop 414.

Referring to FIGS. 14A and 15A, the sleeve 240 is in an at-rest position, with a gap G defined between the stops, or stop surfaces 285, 287 thereof. This gap is the total travel distance of the sleeve 240 in a typical actuation. The gap (G) can be fixed as manufactured (FIG. 15A), or the gap may be user adjustable (FIG. 14A). The gap shown in FIG. 14A is user adjustable from 0.4 mm (maximum) to 0 (minimum), but this value may be more than 0.4 mm. The first rollback distance (R1) is defined as the flex distance of the rollback seal 256 disposed between the sleeve 240 and housing 222, and may be typically equal to the gap value G. As shown in FIG. 15B, in an actuated position, the rollback seal 256 flexes or deforms, for example by engaging the stop surface 266 and having a portion move into the second portion 264 of the gland. Referring to the embodiment of FIG. 14A, second rollback distance (R2) is the flex distance of piston seal 258. While the piston seal 258 also provides slide advancement of the piston 242 relative to the sleeve 240, the seal 258 may also has provide some flex distance (R2) that increases the overall rollback capability of the system. In this embodiment, the piston seal 258 defines a deformable second rollback seal engaged with the piston, wherein the second rollback seal biases the piston from an actuated position toward an at-rest position. In other embodiments, shown for example in FIG. 17, the piston seal 258 does not provide any rollback, but rather slides relative to the sleeve. The rollback seal provides a first rollback distance (R1) and the piston seal, or second rollback seal, provides a second rollback distance (R2), wherein the first rollback distance is greater than the second rollback distance (R1>R2).

The adjustment range (A) is provided by movement of the adjuster 400 along the axial direction 8 relative to the housing 222, for example by rotation and threadable engagement between the adjuster and housing. In other embodiments, axial adjustment may be made by clamping/releasing of the adjuster, predetermined detents and other suitable advancement systems. As the distance A is increased, the size of the gap (G) is decreased. When the G=max (e.g., 0.4 mm), then the adjusted distance A=0 in the embodiment shown, for example in FIG. 14A.

The total rollback, or flex distance, of the piston and sleeve is Rt=R1+R2, which may be the same as gap between the brake pad 212 and rotor 208. In one embodiment, the total rollback Rt has a maximum range of 0.4 (R1)+0.1 (R2)=0.5 mm when the adjustment A=0 (FIG. 14A). Total rollback has a middle range of 0.2 (R1)+0.1 (R2)=0.3 mm when the adjust A=0.2 mm (FIG. 14B). Total rollback has a minimum range of 0(R1)+0.1(R2)=0.1 mm when the adjust A=0 (FIG. 14C). When the slave piston is fully actuated with the brake pads 212 in contact with the brake rotor 208, R1=0, R2=0, and there is no pad-to-rotor gap (G=0). These general values and ranges may be smaller or larger in other embodiments or configurations.

Referring to FIGS. 10 and 14A-D, the stop 289 is coupled to the housing 222 and is spaced apart from the stop surface 266 in an axial direction, wherein a distance between the stop 289, or stop surface 287, and the stop surface 266 is fixed. A piston assembly, which may include the sleeve 240 and piston 242, is slidable relative to the caliper housing 222 in the axial direction 8 between the at-rest position, wherein the piston assembly, e.g., sleeve 240, is engaged with a stop 414, 452, and an actuated position, wherein the piston assembly, e.g., sleeve 240, is engaged with the stop 289. The rollback seal 256 is disposed in the gland 260 between, and engaged with, the piston assembly (e.g., sleeve 240) and the caliper housing 222. In one embodiment, the piston assembly may include an integral sleeve and piston. In one embodiment, the rollback adjuster 400 defines the stop 414, wherein the rollback adjuster is coupled to the caliper housing 222. The rollback adjuster 400 is adjustable between a maximum rollback position, wherein the 414 stop is spaced from the stop 289 a first distance, and a minimum rollback position, wherein the second stop 414 is spaced from the stop 289 a second distance, wherein the first distance is greater than the second distance

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

Although embodiments have been described for illustrative purposes, those skilled in the art will appreciate that various modifications, additions, and substitutions are possible, without departing from the scope and spirit of the disclosure. It is therefore intended that the foregoing description be regarded as illustrative rather than limiting, and that it be understood that all equivalents and/or combinations of embodiments and examples are intended to be included in this description.

Although certain parts, components, features, and methods of operation and use have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A brake caliper comprising:
a caliper housing comprising a first cavity;
a sleeve disposed in the first cavity, wherein the sleeve is reciprocally slidable relative to the caliper housing along an axial direction, and wherein the sleeve comprises a second cavity;
a piston disposed in the second cavity, wherein the piston is reciprocally slidable relative to the sleeve along the axial direction;
a first seal disposed between the sleeve and the caliper housing; and
a second seal disposed between the piston and the sleeve.

2. The brake caliper of claim 1 wherein the caliper housing comprises a first interior surface defining the first cavity, wherein the rollback sleeve comprises a first exterior surface and a second interior surface defining the second cavity, wherein the piston comprises a second exterior surface, wherein the first seal engages the first interior surface and the first exterior surface, and wherein the second seal engages the second interior surface and the second exterior surface.

3. The brake caliper of claim 1 further comprising first and second stops spaced apart along the axial direction, wherein the sleeve is moveable between an actuated position, wherein the sleeve engages the first stop, and an at-rest position, wherein the sleeve engages the second stop.

4. The brake caliper of claim 3 wherein a space between the first and second stops is adjustable.

5. The brake caliper of claim 4 further comprising a rollback adjuster moveably coupled to the caliper housing, wherein the rollback adjuster is moveable along the axial direction relative to the caliper housing, and wherein the rollback adjuster comprises the second stop.

6. The brake caliper of claim 5 wherein the rollback adjuster is threadably engaged with the caliper housing.

7. The brake caliper of claim 1 wherein the first seal comprises a deformable first rollback seal engaged with the sleeve, wherein the first rollback seal biases the sleeve from an actuated position toward an at-rest position.

8. The brake caliper of claim 7 wherein the second seal comprises a deformable second rollback seal engaged with the piston, wherein the second rollback seal biases the piston from an actuated position toward an at-rest position.

9. The brake caliper of claim 8 wherein the first rollback seal provides a first rollback distance and the second rollback seal provides a second rollback distance, wherein the first rollback distance is greater than the second rollback distance.

10. The brake caliper of claim 7 wherein the caliper housing comprises a peripheral gland housing the first rollback seal, wherein the gland has a first width defined in the axial direction and wherein the first rollback seal has a second width defined in the axial direction, wherein the first width is greater than the second width.

11. The brake caliper of claim 10 wherein the gland comprises first and second portions, wherein the first rollback seal is disposed in the first portion, and wherein a portion of the first rollback seal is deformable into the second portion of the gland as the sleeve is moved relative to the caliper housing.

12. The brake caliper of claim 1 further comprising a ring disposed between the piston and the interior surface of the sleeve adjacent the second seal.

13. A brake caliper comprising:
a caliper housing comprising a first cavity;
a sleeve disposed in the first cavity, wherein the sleeve is moveable relative to the caliper housing along an axial direction, and wherein the sleeve comprises a second cavity;
a piston disposed in the second cavity, wherein the piston is moveable relative to the sleeve along the axial direction;
a first seal disposed between the sleeve and the caliper housing;
a second seal disposed between the piston and the sleeve;
a first stop disposed on the caliper housing; and
a second stop spaced apart from the first stop along the axial direction, wherein a space between the first and second stops is adjustable, wherein the sleeve is moveable between an actuated position, wherein the sleeve engages the first stop, and an at-rest position, wherein the sleeve engages the second stop.

14. The brake caliper of claim 13 further comprising a rollback adjuster moveably coupled to the caliper housing, wherein the rollback adjuster is moveable along the axial direction relative to the caliper housing, and wherein the rollback adjuster comprises the second stop.

15. The brake caliper of claim 14 wherein the rollback adjuster is threadably engaged with the caliper housing.

16. The brake caliper of claim 13 wherein the first seal comprises a deformable first rollback seal engaged with the sleeve, wherein the first rollback seal biases the sleeve from an actuated position to an at-rest position.

17. The brake caliper of claim 16 wherein the second seal comprises a deformable second rollback seal engaged with the piston, wherein the second rollback seal biases the piston from an actuated position to an at-rest position.

18. The brake caliper of claim 16 wherein the caliper housing comprises a peripheral gland housing the first rollback seal, wherein the gland comprises first and second portions, wherein the first rollback seal is disposed in the first portion, and wherein a portion of the first rollback seal is deformable into the second portion of the gland as the sleeve is moved relative to the caliper housing.

19. A brake caliper comprising:
a caliper housing comprising a gland defining a stop surface;
a first stop coupled to the housing and spaced apart from the stop surface in an axial direction, wherein a distance between the first stop and the stop surface is fixed;
a piston assembly slidable relative to the caliper housing in the axial direction between an at-rest position, wherein the piston assembly is engaged with a second stop, and an actuated position, wherein the piston assembly is engaged with the first stop;
a rollback seal disposed in the gland between, and engaged with, the piston assembly and the caliper housing; and
a rollback adjuster defining the second stop, wherein the rollback adjuster is coupled to the caliper housing, wherein the rollback adjuster is adjustable between a maximum rollback position, wherein the second stop is spaced from the first stop a first distance, and a minimum rollback position, wherein the second stop is spaced from the first stop a second distance, wherein the first distance is greater than the second distance.

20. The brake caliper of claim 19 wherein the piston assembly comprises a sleeve slidably disposed in the caliper housing and engaged with the rollback seal, and a piston slidably disposed in the sleeve.
